(19) United States
(12) Patent Application Publication
(10) Pub. No.: US 2010/0122860 A1
(43) Pub. Date: May 20, 2010

(54) Electric off-road vehicle drive

(76) Inventor: Albert T. McKelvey, Gibsonia, PA (US)

Correspondence Address: ALBERT T. McKELVEY, 5858 VALENCIA RD., GIBSONIA, PA, 15044, US

(21) Appl. No.: 12/292,402

(22) Filed: Nov. 18, 2008

(51) Int. Cl. B60K 1/00

(52) U.S. Cl. 180/65.1

(57) ABSTRACT

The electric off-road vehicle drive has an electric DC motor for replacing an internal combustion engine in an off-road vehicle. A plurality of batteries are connected to the electric DC motor for providing power and for providing counterweight in the off-road vehicle. To charge the batteries, a high frequency battery charger is connected to the batteries. The charger charges one of the batteries while the other battery provides power to the DC motor. At least one electric DC motor speed controller is connected to the motor for controlling the speed of the motor. The electric off-road vehicle drive then connects to hydraulic parts of the off-road vehicle, provides power, and moves the off-road vehicle. The electric off-road vehicle drive can replace the engines in bulldozers, excavators, loaders, skidders, soil compactors, tractors, handlers, or any other type of earth moving or clearing equipment.

### BACKGROUND OF THE INVENTION

1. Field of the Invention

The present invention relates to earth moving or clearing vehicles that operate, usually, off road and power to operate these vehicles. More particularly, the present invention relates to an electric off-road vehicle drive for powering earth moving or clearing vehicles, and farm equipment.

2. Description of the Related Art

Electric motor powered wheeled vehicles are well known in the art and have sparked continued interest as an alternate power source. Of course, a problem in the development of electric vehicles suitable for modern demands is the difficulty of producing a vehicle of reasonable cost, size and performance using available electric power storage systems.

Electric powered vehicles compete with internal combustion powered vehicles in the transportation of humans. However, in earth moving or clearing vehicles, internal combustion is preferred. Improved battery systems having deep cycle charges have been developed, but the cost and weight of sufficient numbers of such batteries to extend range have created further problems which negate the acceptance of electric vehicles as a choice for these off-road or earth moving and clearing vehicles.

Concerns about air pollution emitted by gasoline or diesel fuel powered automobiles, the cost of fuel, and noise pollution have led to a great interest in the area of alternative means for powering vehicles such as automobiles. Of particular interest are vehicles that are powered in whole or in part by electrical energy. These vehicles are typically powered by the electrical energy provided by a battery.

Vehicles known as earth-moving type equipment have at least one hydraulic drive which is controlled by a hydraulic pump. The pump is driven by an internal-combustion engine. This type of equipment or vehicle are fitted, at the front or at the rear, with buckets, loading shovels, blades, lifting forks, excavators, mills, drills, rotating brushes or equipment of any kind and are hydraulically powered.

Vehicles or equipment of this kind are extremely effective at moving or clearing earth, but there are drawbacks with their internal-combustion engines. The engines emit exhaust gases and produce noise at levels that are particularly unwanted. Additionally, these types of earth moving or off-road vehicles consume significant amounts of gasoline or diesel fuel. However, even though there are attempts to solve America's oil consumption problem, there has not been any realistic attempts at electrically powering the off-road vehicle.

Thus, an electric off-road vehicle drive solving the aforementioned problems is desired.

### SUMMARY OF THE INVENTION

The electric off-road vehicle drive includes an electric DC motor for replacing an internal combustion engine in an off-road vehicle. A plurality of batteries are connected to the electric DC motor for providing power and for providing counterweight in the off-road vehicle. To charge the batteries, a high frequency battery charger is connected to the batteries. The high frequency battery charger charges one of the batteries while the other battery provides power to the electric DC motor. There is at least one electric DC motor speed controller connected to the motor that controls the speed of the motor. The electric off-road vehicle drive then connects to hydraulic parts of the off-road vehicle, such as the high-pressure hydraulic pump that is driven by the motor. A hydrostatic drive is connected to the high-pressure hydraulic pump and to a planetary final drive. The motor now can power the planetary final drive that is connected to a pair of moving members or treads for moving the off-road vehicle. A hydraulic cooling fan maintains the temperature and air flow over the electric off-road vehicle drive.

The drive further includes for the operator at least one motor controller switches for controlling the motor, and a battery pack change over switch connected to the frequency battery charger for controlling the charging of the batteries.

These and other features of the present invention will become readily apparent upon further review of the following specification and drawings.

### BRIEF DESCRIPTION OF THE DRAWINGS

FIG. 1 is an environmental, perspective view of an electric off-road vehicle drive mounted in a bulldozer according to the present invention.

FIG. 2 is a circuit diagram of the electric off-road vehicle drive according to the present invention.

FIG. 3 is an environmental, perspective view of the electric off-road vehicle drive mounted in an excavator according to the present invention.

Similar reference characters denote corresponding features consistently throughout the attached drawings.

### DETAILED DESCRIPTION OF THE PREFERRED EMBODIMENTS

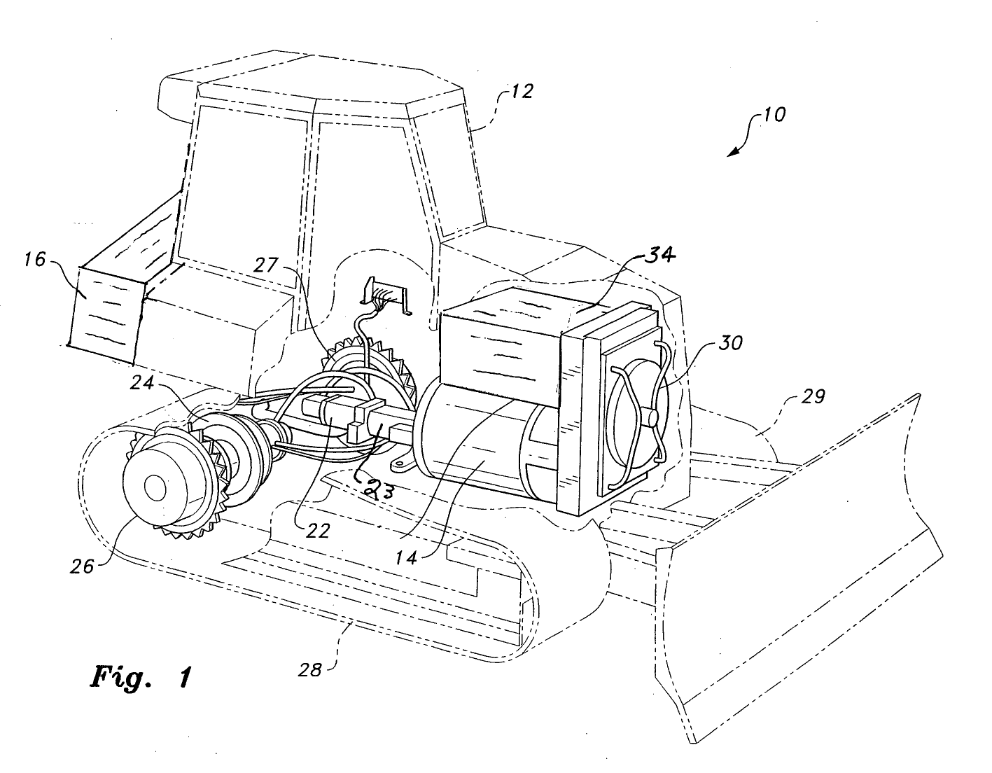

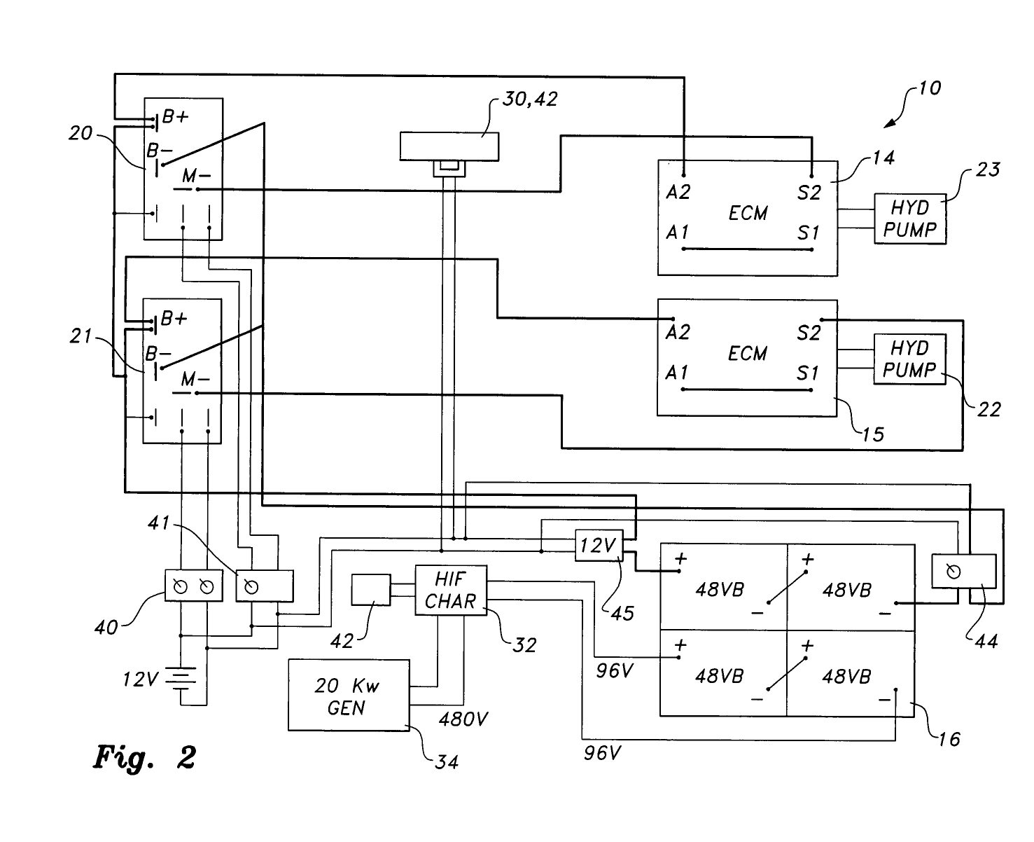

As shown in FIG. 1, the present invention relates to an electric off-road vehicle drive, generally designated as 10 in the drawings, which may be mounted in a bulldozer 12 or other earth moving or off-road vehicle. FIG. 2 illustrates a circuit diagram for the electric off-road vehicle drive 10. The electric off-road vehicle drive 10 replaces either a diesel or gas engine with an electric DC motor 14. A set of commercial batteries 16 powers the electric motor 14, in the bulldozer 12. The commercial battery set 16 can be 36 volts, 48 volts, 72 volts, 96 volts, 120 volts, or 144 volts. The voltage of the battery set 16 depends on the size of the equipment. For example, with smaller bulldozer like bulldozer 12 shown in FIG. 1, there is only one set of batteries and one electric motor 14. However, larger bulldozers will have two sets of batteries and two electric motors, as shown in the circuit diagram of FIG. 2.

As shown in FIG. 2, the battery set 16 includes four 48-volt batteries. Most equipment, such as the bulldozer 12 or other types of earth moving equipment, has counterweights weighing 3,000 to 40,000 lbs. For installing the electric off-road vehicle drive 10, some of this counterweight in the bulldozer 12 or other equipment is removed and the battery set 16 will replace some of that weight. Thus, the battery set 16 not only performs the function of providing power, but also the battery set 16 provides counterweight for the bulldozer 12 or the other types of earth moving equipment.

A pair of electric DC motor speed controllers 20, 21 control the motors 14, 15. The motors 14, 15 drive high-pressure hydraulic pumps 22, 23. The hydraulic pumps 22, 23 are each connected to a corresponding hydrostatic drive, generally numbered 24. The hydrostatic drive 24 is then connected to respective planetary final drives 26, 27 that rotate treads 28, 29 of the bulldozer 12 or other earth moving equipment. A hydraulic cooling fan 30 maintains the temperature and air flow over the electric off-road vehicle drive 10. The hydraulic features, such as the pump 22, 23, drive 24, and fan 30, as well as the planetary final drives 26, 27 are standard pieces of equipment found in the bulldozers and other earth moving or clearing types of equipment.

The batteries 16 are recharged in about two hours by a high frequency battery charger 32. The charger 32 obtains its power from an AC three phase generator set 34 that can be from 20 to 80 KW. When used with bulldozer 12, the AC three phase generator set 34 is 20 KW, but it can also be run by diesel power. The generator 34 outputs 480V of power to the charger 32. The generator 34 only requires two hours to recharge a battery from the battery set 16 for six hours usage of power on the bulldozer 12 or other equipment.

The charger 32 converts the received 480V from the generator 34 and powers the battery set 16 with 96V. The charger 32 can be any of the known high frequency battery chargers on the market. Currently, one such charge is the AccelRate™ SC260, manufactured by Power Systems, Inc. at 1370-1140 West Pender Street, Vancouver, BC Canada V6E 4G1. These smart charges, such as the AccelRate™ SC260, will work with all popular lead-acid battery chemistries, including vented, gas recombination, gel or glass mat. A substantially higher charging current can be applied and maintained, resulting in a much faster charge, without any substantial increase in the electrolyte temperature. Lead-acid industrial motive power batteries will be returned to a full state of charge in approximately two hours, while greatly reducing energy demands.

Part of the efficiency of the electric off-road vehicle drive 10 comes from being able to run the two smaller hydraulic pumps 22, 23 with half a flow rate of a larger one that is presently being used in a large diesel engine. By powering the hydraulic pumps 22, 23 with the two smaller electric motors 14, 15, a high torque is reached at a much lower revolution per minute. The electric motors 14, 15 become much more efficient than the diesel engine. In fact, there are many functions of the bulldozer 12 or other equipment that do not require the large flow rate of a single pump. Therefore, it is usually only necessary to have one of the tandem electric motors 14, 15 running.

This is the same basic principal used by a diesel locomotive on a train. The train has a diesel engine turning a generator supplying electric current to the electric motors mounted on the drive wheels of the engine. The train uses the electric motors, because of their high torque at a much lower revolution per minute.

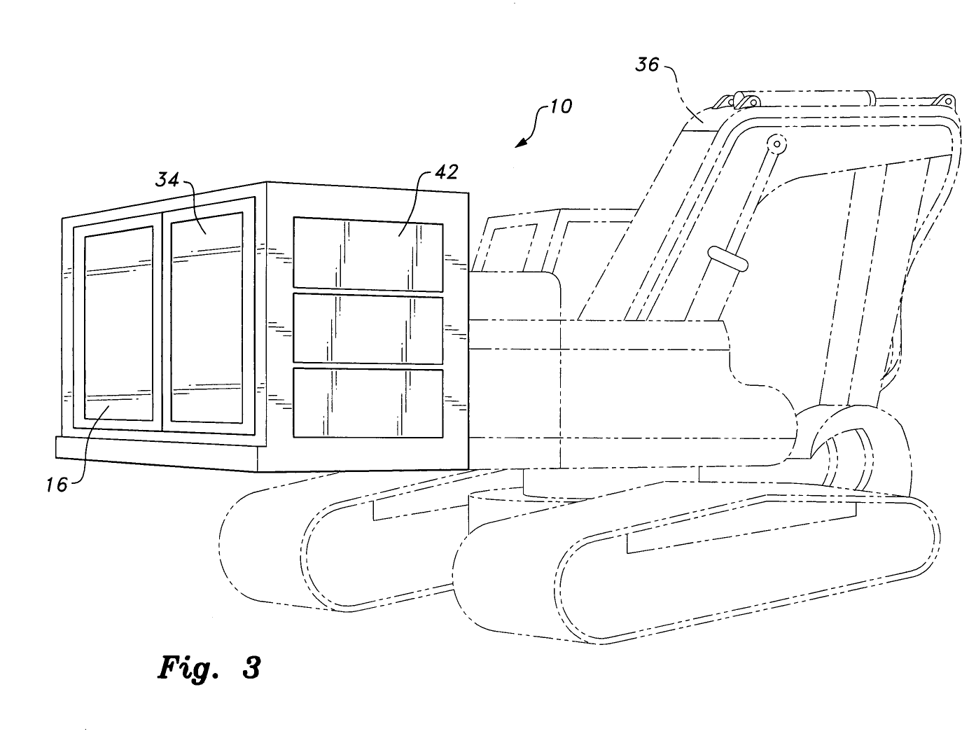

In FIG. 3, an excavator 36 is shown. This is a much larger piece of equipment than the bulldozer 12. However, the hydraulics are the same and the electric off-road drive 10 can be used here too. There is a minor difference between the electric off-road vehicle drive 10 in the bulldozer 12 of FIG. 1 and the one that could be installed in the excavator 36. The difference is in the positioning of a hydraulic cooling fan 42 in the excavator 36. With the bulldozer 12, the hydraulic cooling fan 30 is in the front part of the bulldozer 12, as shown in FIG. 1. In the excavator 36, the hydraulic cooling fan 42 is in the back of the excavator 36, as shown in FIG. 3. The two cooling fans 30, 42 are shown as the same box in circuit diagram of FIG. 2, because they are and it is just the positioning that is different. One other difference may be in the number of batteries in battery set 16 or the voltage requirement, simply because the excavator 36 is a larger machine than the bulldozer 12.

In the cab of the bulldozer 12 and the excavator 36 are motor controller switches 40, 41 and a battery pack change over switch 42. The switches 40, 41 control the motors 14, 15. The battery pack change over switch 42 controls what batteries will be charging in the battery set 16, so that while power from some of the batteries is being used, the non-used batteries are being charged. There are also battery disconnect components 44, 45 for emergency that is also in the cab of the bulldozer 12.

The electric off-road vehicle drive 10 has been described and illustrated with the bulldozer 12 and excavator 36. The drive 10 can also be used with loaders, skidders, soil compactors, tractors, handlers, or any other type of off-road vehicle and earth moving equipment. Currently, this type of equipment is manufactured by a number of different manufactures such as John Deere, Caterpillar, or Komatsu.

Additionally, it has been found that a farm tractor equipped with the electric off-road drive 10 and forty-eight horsepower that, under load, produces up to one hundred horsepower. In fact, the farm tractor used to run on sixteen gallons of gasoline a day for a total cost of $64.00 dollars, at $4.00 per gallon. The same tractor equipped with the electric off-road drive 10 now costs a mere $0.90 of electricity per day. Thus, there is a very good savings without loosing power with the electric off-road vehicle drive 10.

It is to be understood that the present invention is not limited to the embodiments described above, but encompasses any and all embodiments within the scope of the following claims.

I claim:

1. An electric off-road vehicle drive, comprising:
an electric DC motor adapted for mounting in an off-road vehicle;
a plurality of batteries connected to the electric DC motor for providing power and for providing counterweight in the off-road vehicle;
a high frequency battery charger and charging circuit for charging at least one of the plurality of batteries while at least one of the other batteries provides power to the electric DC motor;
at least one electric DC motor speed controller connected to the motor for controlling the speed of the motor;
at least one high-pressure hydraulic pump driven by the motor;
at least one hydrostatic drive connected to the at least one high-pressure hydraulic pump;
at least one planetary final drive connected to the at least one hydrostatic drive; and
a pair of moving members connected to the at least one planetary final drive for moving the off-road vehicle.

2. The electric off-road vehicle drive according to claim 1, further comprising a hydraulic cooling fan connected to said motor for maintaining temperature and air flow over the electric off-road vehicle drive.

3. The electric off-road vehicle drive according to claim 1, further comprising:
at least one motor controller switch connected to said controller for controlling the motor; and
a battery pack changeover switch connected to the battery charger for controlling the charging of the batteries.
